(19) United States
(12) Patent Application Publication
(10) Pub. No.: US 2018/0320661 A1
(43) Pub. Date: Nov. 8, 2018

(54) Compact Multi-Disk Rotor Brake System for a Wind Turbine

(71) Applicant: General Electric Company, Schenectady, NY (US)

(72) Inventor: Frank Hinken, Rheine (DE)

(21) Appl. No.: 15/585,199

(22) Filed: May 3, 2017

(51) Int. Cl. F03D 7/02; F03D 9/25; F03D 15/00; F16D 55/02; F16D 55/22

(52) U.S. Cl. CPC F03D 7/0248; F03D 9/25; F03D 15/00; F16D 55/025; F05B 2260/904; F05B 2240/60; F05B 2260/902; F05B 2260/903; F16D 55/22

(57) ABSTRACT

A drivetrain system, braking method and braking system for a wind turbine is disclosed having a generator; a gearbox; a generator shaft and gearbox output shaft coupled between the generator and the gearbox, each shaft extending along a common longitudinal axis; a brake system having at least two brake disks with a first brake disk and a second brake disk, the first and second brake disks mounted concentric with the longitudinal axis; and a plurality of disk brake calipers having a first brake caliper and a second brake caliper, the first and second brake calipers mounted concentric with the longitudinal axis and engaged with the first and second brake disks, respectively.

### FIELD OF THE INVENTION

The present subject matter relates generally to wind turbines and, more particularly, to systems and methods for braking the rotor of a wind turbine that facilitates slowing and/or stopping the rotation of the drive train.

### BACKGROUND OF THE INVENTION

Generally, a wind turbine includes a tower, a nacelle mounted on the tower, and a rotor coupled to the nacelle. The rotor generally includes a rotatable hub and a plurality of rotor blades coupled to and extending outwardly from the hub. Each rotor blade may be spaced about the hub so as to facilitate rotating the rotor to enable kinetic energy to be converted into usable mechanical energy, which may then be transmitted to an electric generator disposed within the nacelle for the production of electrical energy. Typically, a gearbox is used to drive the electric generator in response to rotation of the rotor. For instance, the gearbox may be configured to convert a low speed, high torque input provided by the rotor to a high speed, low torque output that may drive the electric generator.

A braking mechanism for the rotor is typically provided for the wind turbine generator (WTG), separate from the yaw braking system. The rotor braking mechanism may be used to control the speed of the WTG, stop the rotor from spinning, and to hold the rotor after it has been stopped. Often the rotor brake system for the WTG is a disk-type brake.

Current rotor braking systems have reached design limits for heat capacity of the brake disk, wear rate of brake pads and overall brake capacity. A larger capacity brake system is required for controlling and braking newer WTG's. Accordingly, a compact brake system that fits into the existing installation space and has a higher capacity would be welcomed in the art.

### BRIEF DESCRIPTION OF THE INVENTION

Aspects and advantages of the invention will be set forth in part in the following description, or may be obvious from the description, or may be learned through practice of the invention.

In one aspect, a drivetrain system for a wind turbine is disclosed having a generator; a gearbox; a generator shaft and gearbox output shaft coupled between the generator and the gearbox, each shaft extending along a common longitudinal axis; a brake system having at least two brake disks with a first brake disk and a second brake disk, the first and second brake disks mounted concentric with the longitudinal axis; and a plurality of disk brake calipers having a first brake caliper and a second brake caliper, the first and second brake calipers mounted concentric with the longitudinal axis and engaged with the first and second brake disks, respectively.

In another aspect, a method for braking a wind turbine is disclosed as: mounting a first brake disk concentric with a generator shaft adjacent to a generator of the wind turbine; mounting a second brake disk concentric with the gearbox output shaft adjacent to a gearbox of the wind turbine; mounting a first and second brake calipers to the first and second brake disks, respectively; measuring at least one dynamic operating parameter during operation of the wind turbine; and adjusting individual brake torques applied by the first and second brake disks based on the measured dynamic operating parameter so as to obtain an equivalent brake torque to the generator shaft and gearbox output shaft from the first and second brake disks.

In a further aspect, a brake system for a wind turbine is disclosed having: a first brake disk mounted concentric with a longitudinal axis of a generator shaft of a generator of the wind turbine; a second brake disk mounted concentric with the longitudinal axis of the gearbox output shaft; a first brake caliper concentric with the generator shaft and engaged with the first brake disk; and a second brake caliper concentric with the gearbox output shaft and engaged with the second brake disk.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine of conventional construction;

FIG. 2 illustrates a perspective, interior view of one embodiment of a nacelle of a wind turbine;

FIG. 3 illustrates a schematic diagram of one embodiment of suitable components including a disk braking system;

FIG. 4 illustrates a typical embodiment for a two-disk braking system;

FIG. 5 illustrates a typical embodiment for a three-disk braking system; and,

FIG. 6 is a block diagram of an exemplary braking method.

Repeat use of reference characters in the present specification and drawings is intended to represent the same or analogous features or elements of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter discloses a system and methods for applying brakes to the rotating power train shaft of a WTG that facilitates slowing and/or stopping the rotation of rotor 18 and/or electrical generator 24. In the exemplary embodiment, disk brake system 40 is a mechanical brake and includes a at least one brake disk 42, 46 and at least one brake caliper 44, 48 removably engaged with the brake disk 42, 46. The disk brake system 40 may include any suitable brake system including, without limitation, a mechanical brake system, a hydraulic brake system, a pneumatic brake system, and an electromagnetic brake system.

Braking capacity and durability requirements for rotor braking systems are increasing as advanced control systems apply braking for WTG load control as well as braking for event response, shutdown, and rotor position retention during maintenance. Limited installation space is available for larger capacity braking systems due to maintenance access requirements for other drive train components, for example the generator and gearbox, as well as bedframe sizing and nacelle clearances available for larger and/or additional braking equipment.

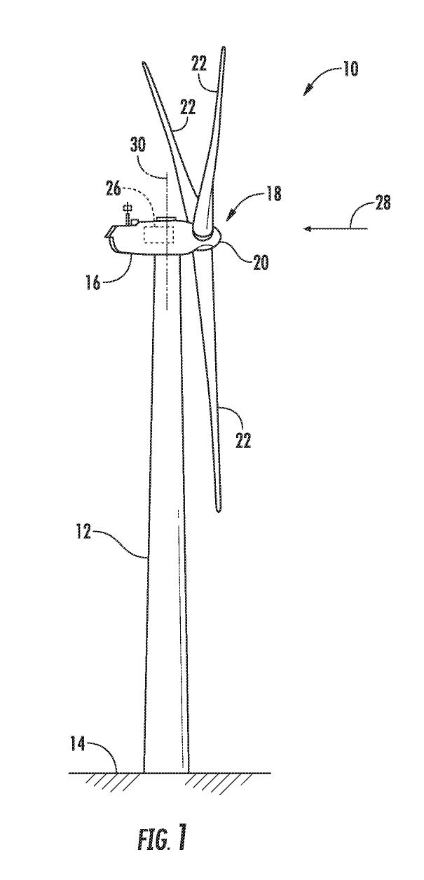

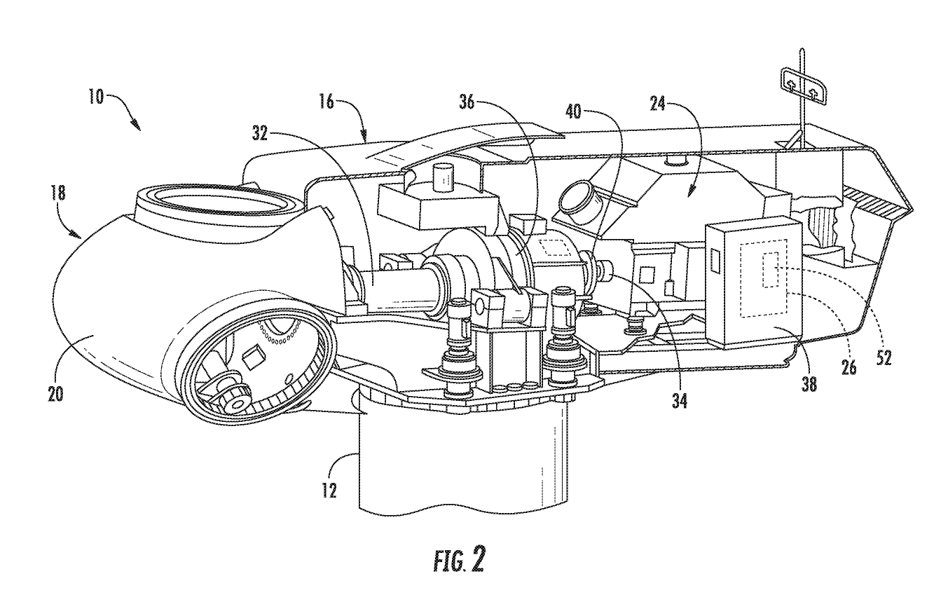

Referring now to the drawings, FIG. 1 illustrates a perspective view of one embodiment of a wind turbine 10 of conventional construction. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or a turbine controller 26 centralized within the nacelle 16. However, it should be appreciated that the turbine controller 26 may be disposed at any location on or in the wind turbine 10, at any location on the support surface 14 or generally at any other location. In general, the turbine controller 26 may be configured to communicate with a plurality of sensors 56 to transmit and execute wind turbine control signals and/or commands in order to control the various operating modes (e.g., braking, start-up or shut-down sequences) and/or components of the wind turbine 10. For example, the controller 26 may be configured to control the blade pitch or pitch angle of each of the rotor blades 22 (i.e., an angle that determines a perspective of the rotor blades 22 with respect to the direction 28 of the wind) to control the load and power output generated by the wind turbine 10 by adjusting an angular position of at least one rotor blade 22 relative to the wind. For instance, the turbine controller 26 may control the pitch angle of the rotor blades 22, either individually or simultaneously, by transmitting suitable control signals/commands to a pitch drive or pitch adjustment mechanism (not shown) of the wind turbine 10. Further, as the direction 28 of the wind changes, the turbine controller 26 may be configured to control a yaw direction of the nacelle 16 about a yaw axis 30 to position the rotor blades 22 with respect to the direction 28 of the wind, thereby controlling the load and power output generated by the wind turbine 10. For example, the turbine controller 26 may be configured to transmit control signals/commands to a yaw drive mechanism (not shown) of the wind turbine 10 such that the nacelle 16 may be rotated about the yaw axis 30.

Referring now to FIG. 2, a simplified, internal view of one embodiment of a nacelle 16 of a wind turbine 10 is illustrated. As shown, a generator 24 may be disposed within the nacelle 16. In general, the generator 24 may be coupled to the rotor 18 of the wind turbine 10 for producing electrical power from the rotational energy generated by the rotor 18. For example, as shown in the illustrated embodiment, the rotor 18 may include a rotor shaft 32 coupled to the hub 20 for rotation therewith. The rotor shaft 32 may, in turn, be rotatably coupled to a generator shaft 34, sometimes referred to as the high speed shaft (HSS), of the generator 24 through a gearbox 36 having a gearbox output shaft 35. As is generally understood, the rotor shaft 32 may provide a low speed, high torque input to the gearbox 36 in response to rotation of the rotor blades 22 and the hub 20. The gearbox 36 may then be configured to convert the low speed, high torque input to a high speed, low torque output to drive the generator shaft 34 (HSS), and thus, the generator 24.

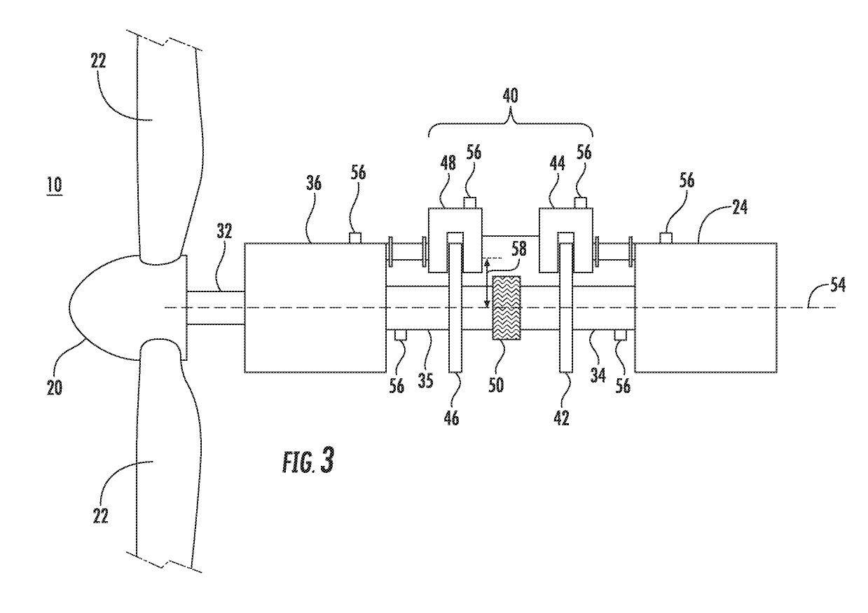

As seen in FIGS. 2 and 3, coupled between the generator 24 and the gearbox 36 along a longitudinal axis 54, a brake system 40 having at least two disks coupled to the generator shaft 34 (HSS) and gearbox output shaft 35 can be configured for performing braking operations for the WTG drive train. At least two brake disks 42, 46 can be mounted normal to and concentric with the generator shaft 34 and gearbox output shaft 35. A plurality of disk brake calipers 44, 48, arranged concentrically with the generator shaft 34 and gearbox output shaft 35, can be adapted to engage with the at least two brake disks 42, 46.

It should be appreciated that additional brake disks and associated disk brake calipers can be similarly configured on the generator shaft 34 and gearbox output shaft 35, as well as in other drive train locations, for example on the rotor shaft 32, inside the gearbox 36, inside the generator 24, and inside the hub 20, as space allows. Multiple smaller diameter brake disks and associated brake calipers, having smaller individual braking capacities, can be configured on the WTG drive train and combined for providing braking requirements. It should also be appreciated that the diameter and thickness of each brake disk can vary to accommodate specific braking requirements at individual disk locations. For example, the second brake caliper 48 engaging with the second brake disk 46 may require higher brake torque than the first brake caliper 44 engaging with the first brake disk 42 in order to minimize torsional forces on the flexible coupling 50 during braking. Thus, individually-variable brake torque can be applied using different diameter brake disks 42, 46 as well as positioning the brake calipers 44, 48 at different radial distances 58 from the longitudinal axis 54. Also, individually-variable brake torque can be applied to each brake disk in response to control signals from the disk brake system control circuit 52.

Additionally, as indicated above, a turbine controller 26 may also be located within the nacelle 16 of the wind turbine 10. For example, as shown in the illustrated embodiment, the turbine controller 26 is disposed within a control cabinet 38 mounted to a portion of the nacelle 16. However, in other embodiments, the turbine controller 26 may be disposed at any other suitable location on and/or within the wind turbine 10 or at any suitable location remote to the wind turbine 10. The turbine controller 26 may be configured with a disk brake system control circuit 52 to communicate with sensors 56 and transmit control signals/commands to the disk brake system 40 of the wind turbine 10 such that the rotor 18 speed can be controlled to limit structural and mechanical loads on the wind turbine 10, stop rotation of the rotor 18, and/or hold a stopped position of the rotor 18 during shutdown and maintenance.

FIG. 3 illustrates a simplified arrangement for a typical disk brake structure for a wind turbine generator. Multiple wind turbine blades 22 are attached to a rotor hub 20. A rotor shaft 32 from the hub 20 is tied to a gearbox 36. A generator shaft 34 and gearbox output shaft 35 aligned between the gearbox 36 and the generator 24 drives wind turbine generator 24. Coupled between the gearbox 36 and the wind turbine generator 24 along the longitudinal axis 54 of the generator shaft 34 is a disk brake system 40. The disk brake system 40 includes at least one cylindrical brake disk 42, 46 on the generator shaft 34 and gearbox output shaft 35 and brake calipers 44, 48 mounted to the generator 24 and gearbox 36, respectively. Although only one brake caliper 44, 48 is shown, a plurality of brake calipers may also be mounted circumferentially around each cylindrical brake disk 42, 46.

The brake disks 42, 46 may typically be about 0.8 m to 1.2 m in diameter, with a thickness of about 25 mm to 50 mm thick, however thickness and diameter can vary for individual brake disks on the same drive train. The disks may weigh about 100 kg to 500 kg each. The weight of the brake disks 42, 46 can be a significant load for bearing supports on the power train. Further, the positioning of the brake disks 42, 46 between the gearbox 36 and the generator 24 adds length to overall axial size of the power train. The positioning of the brake disks 42, 46 can also restrict access to the internals (not shown) of the wind turbine generator 10. Such limits on access may make maintenance on the internals of the wind turbine generator 10 more difficult. Access can be improved by distributing components of the braking system 40 into smaller and lighter disks and calipers along different sections of the drive train and strategically placing the smaller components for maintenance access.

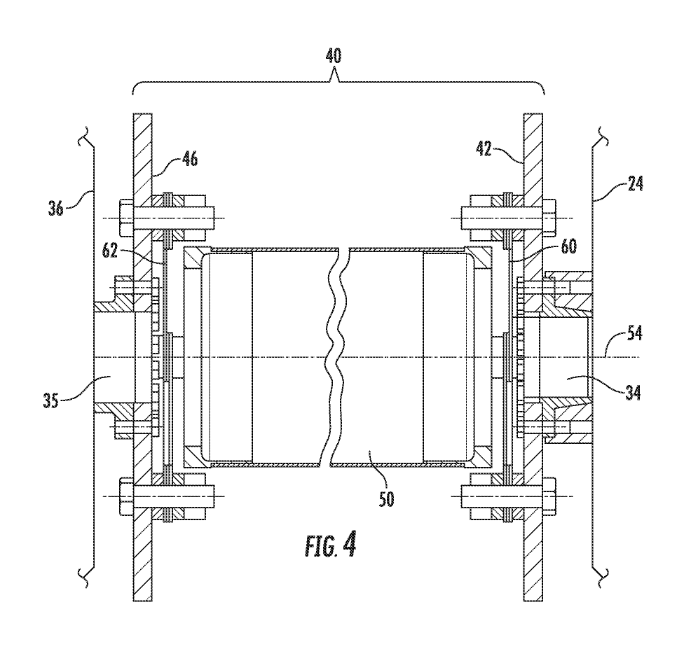

Referring now to FIG. 4, an axial cross section view of a two-disk embodiment is shown. A plurality of brake calipers (not shown) may be provided arranged concentrically with the generator shaft 34 and gearbox output shaft 35, and adapted to engage the first and second brake disks 42, 46. Braking capacity (brake torque) from each disk can vary. Individual brake calipers may be mounted with an open end directed outward radially so as to position the brake pads to engage the braking surface of the brake disks 42, 46. The plurality of brake calipers may be disposed with equal or un-equal spacing circumferentially around the brake disks 42, 46. The disk brake calipers may be mounted to and supported by the generator 24 casing and/or the gearbox 36 casing using bolts or other known mechanical means. A flexible coupling 50 is disposed between the first and second brake disks 42, 46, along the longitudinal axis 54, to transmit rotational power while accommodating some misalignment between the generator 24 and the gearbox 36. The disk brake system 40 has a compact form-factor enabled by coupling the first and second brake disks 42, 46 with the first and second disk packs 60, 62 of the flexible coupling 50, thereby decreasing the overall length of the braking system 40 along the longitudinal axis 54. The brake disks 42, 46 may be mounted to and supported by the disk packs 60, 62 using bolts or other known mechanical means. The brake disks 42, 46 can also be coupled to the generator shaft 34 using bolts or other known mechanical means.

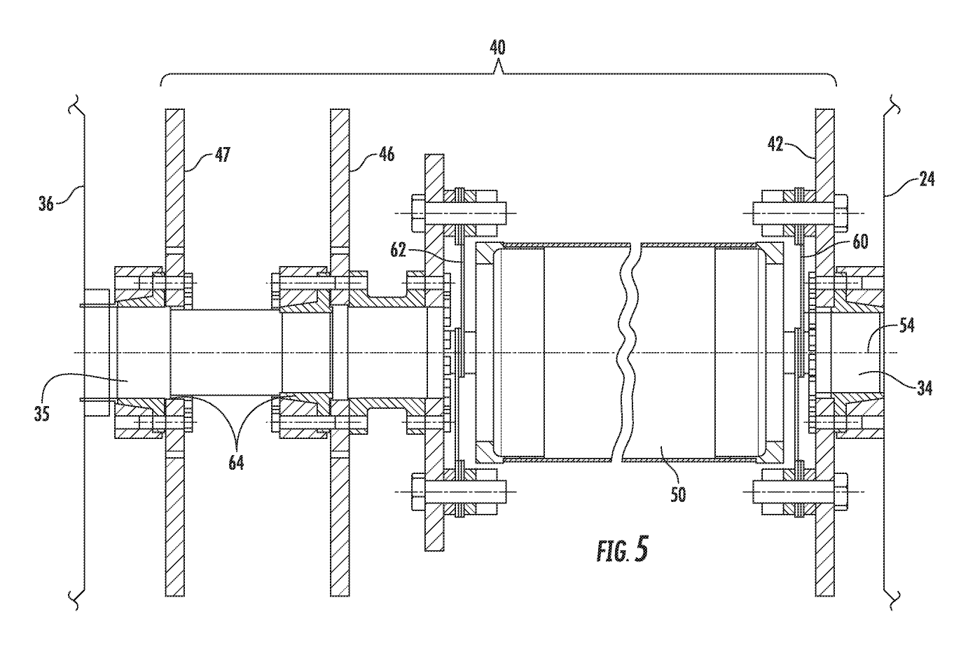

FIG. 5 shows an axial cross section view of a three-disk embodiment. A plurality of brake calipers (not shown) may be provided arranged concentrically with the generator shaft 34 and gearbox output shaft 35 and adapted to engage the first, second and third brake disks 42, 46, 47, with the second and third brake discs 46, 47 positioned toward the gearbox 36 end of the gearbox output shaft 35. Braking capacity (brake torque) from each brake disk can vary. Individual brake calipers may be mounted with an open end directed outward radially so as to position the brake pads to engage the braking surface of the brake disks 42, 46, 47. The plurality of brake calipers may be disposed with equal or un-equal spacing circumferentially around the brake disks 42, 46, 47. The disk brake calipers may be mounted to and supported by the generator 24 casing and/or the gearbox 36 casing using bolts or other known mechanical means. A flexible coupling 50 is disposed between the first and second brake disks 42, 46, along the longitudinal axis 54, to transmit rotational power while accommodating some misalignment between the generator 24 and the gearbox 36. The brake disks 42, 46, 47 may be mounted to and supported by the disk packs 60, 62 or spool pieces 64 using bolts or other known mechanical means. The brake disks 42, 46 can also be coupled to the gearbox output shaft 35 and/or generator shaft 34 using bolts and spool pieces 64 or other known mechanical means.

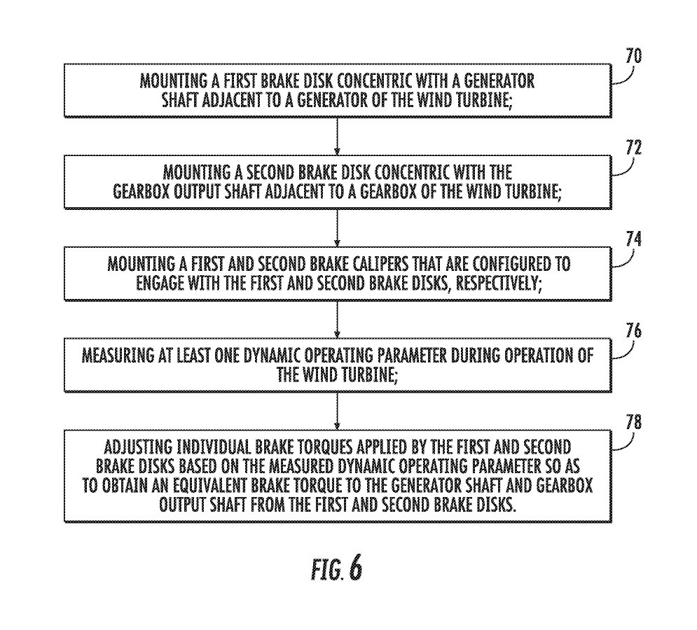

As shown in FIG. 6, the turbine controller 26 and associated disk brake system control circuit 52 can execute a method for braking a wind turbine 10, having the steps of: 70 mounting a first brake disk normal to and concentric with a generator shaft adjacent to a generator of the wind turbine; 72 mounting a second brake disk normal to and concentric with the gearbox output shaft 35 adjacent to a gearbox 36 of the wind turbine; 74 mounting a first brake caliper to the first brake disk and a second brake caliper to the second brake disk; 76 measuring at least one dynamic operating parameter of the wind turbine during operating thereof; and, 78 adjusting individual brake torques applied by the first and second brake disks in response to the measured dynamic operating parameter so as to obtain an equivalent brake torque to the generator shaft 34 and gearbox output shaft 35 from the first and second brake disks.

The wind turbine controller 26 can include a plurality of sensors 56 (see FIG. 3) coupled to one or more components of wind turbine 10 and/or the electrical load for measuring dynamic operating parameters of such components and/or measuring other ambient conditions. Sensors 56 may include, without limitation, one or more sensors 56 configured to measure any ambient condition, any operational parameter of any wind turbine component, displacement, yaw, pitch, moments, strain, stress, twist, damage, failure, rotor torque, rotor speed, an anomaly in the electrical load, and/or an anomaly of power supplied to any component of wind turbine 10. Sensors 56 may be operatively coupled to any component of wind turbine 10 and/or the electrical load at any location thereof for measuring any parameter thereof, whether such component, location, and/or parameter is described and/or shown herein, and may be used to derive other measurements, e.g., viscosity, as known in the art. In the exemplary embodiment, each sensor is coupled in electronic data communication to turbine controller 26 for transmitting one or more suitable signals to the disk brake system control circuit 52 that processes the suitable signals from the controller 26 to control the disk brake system 40.

In the exemplary embodiment, sensors 56 include any suitable sensor or combination of sensors 56 including, without limitation the following sensors 56: a power sensor operatively coupled to electrical generator 24 for detecting an electrical power output of electrical generator 24; at least one brake sensor 56 operatively coupled to the disk brake system 40 for detecting a brake torque exerted by individual brake disks of the disk brake system 40; a rotor shaft sensor operatively coupled to rotor shaft 32 for detecting a speed of rotation of rotor shaft 32 and/or a torque of rotor shaft 32; a generator shaft sensor operatively coupled to generator shaft 34 for detecting a speed of rotation of generator rotor shaft 34 and/or a torque of generator rotor shaft 34; a gearbox output shaft sensor operatively coupled to the gearbox output shaft 35 for detecting a speed of rotation of gearbox output shaft 35 and/or a torque of the gearbox output shaft 35; at least one angle sensor operatively coupled to a corresponding rotor blade 22 for detecting a pitch angle of the corresponding rotor blade 22 with respect to wind direction 26 and/or with respect to hub 20; a yaw sensor operatively coupled to a suitable location within or remote to wind turbine 10 for detecting a yaw orientation of nacelle 16; a frequency sensor operatively coupled to rotor 18 for detecting a frequency and/or an eigenfrequency of the rotor 18; an anemometer operatively coupled to a suitable location within or remote to wind turbine 10 for detecting a plurality of wind conditions including, without limitation, wind direction, wind velocity, wind shear, wind gradient, and turbulence intensity.

In the exemplary embodiment, sensors 56 communicate the dynamic parameter with controller 26 and, more specifically, transmit a signal that indicates the detected parameter to controller 26 that communicates with the braking control circuit 52. Controller 26 then determines an operating command for brake system 40 and, more specifically, to individual brake disks via the first caliper 44 and second caliper 48. Controller 26 may control individual brake calipers 44, 48 to increase or decrease a brake torque based on an operational change of wind turbine 10. For example, controller 26 may include a control or notch filter (not shown) that facilitates determining the operating command for adjusting a force applied by individual brake calipers 44, 48. The notch filter may have any suitable input including, without limitation, a brake torque, a shaft parameter, a wind turbine parameter, and an ambient environment parameter.

In the exemplary embodiment, controller 26 determines the operating command for brake system 40 such that the speed and/or torque of the generator shaft 34 and gearbox output shaft 35 is equivalent along the entire length of the combined shaft during braking, i.e. on both sides of the flexible coupling 50. This can minimize torsional forces being applied to the flexible coupling 50 resulting from different braking torques being applied by the first and second brake calipers 44, 48 on the first and second brake disks 42, 46 positioned on opposing sides of the flexible coupling 50.

In the exemplary embodiment, operating commands are determined in a continuous and dynamic manner via at least one algorithm and statically stored electronically within a table (not shown) that is maintained within controller 26. Alternatively, such operating commands may be determined dynamically using at least one algorithm.

In the exemplary embodiment, turbine controller 26 also includes at least one random access memory (RAM) and/or other storage device. RAM and storage device are coupled to a bus to store and transfer information and instructions to be executed by a processor. RAM and/or storage device can also be used to store temporary variables or other intermediate information during execution of instructions by the processor. In the embodiments described herein, memory may include, without limitation, a computer-readable medium, such as a RAM, and a computer-readable non-volatile medium, such as flash memory. Alternatively, a floppy disk, a compact disc-read only memory (CD-ROM), a magneto-optical disk (MOD), a digital versatile disc (DVD), and/or a solid state disc (SSD) may also be used.

In the exemplary embodiment, controller 26 further includes at least one input/output device that facilitates providing input data to controller 26 and/or providing outputs, such as, but not limited to, brake control outputs. Instructions may be provided to memory from a storage device, such as, but not limited to, a magnetic disk, a read-only memory (ROM) integrated circuit, CD-ROM, and/or DVD, via a remote connection that is either wired or wireless providing access to one or more electronically-accessible media and other components. In the embodiments described herein, input channels may include, without limitation, sensors 56 and/or computer peripherals associated with an operator interface, such as a mouse and/or a keyboard. Further, in the exemplary embodiment, output channels may include, without limitation, a control device, an operator interface monitor and/or a display. In certain embodiments, hard-wired circuitry can be used in place of or in combination with software instructions. Thus, execution of sequences of instructions is not limited to any specific combination of hardware circuitry and software instructions, whether described and/or shown herein. In the exemplary embodiment, controller 26 can also include at least one sensor interface that allows controller 26 to communicate with sensors 56.

Processors and circuits described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a PLC cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, brake system control commands. The execution of sequences of instructions is not limited to any specific combination of hardware circuitry and software instructions.

Exemplary embodiments of the disk brake system can lower brake disk operating temperatures because the plurality of brake disks allows brake torque to be distributed to multiple disks. Lower individual brake pad wear is also enabled with the additional brake calipers. Overall brake capacity can be increased with additional brake disks described herein, and the exemplary embodiments can be sized to fit in existing installation space between gearbox and generator.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A drivetrain system for a wind turbine, the drivetrain system comprising:
a generator;
a gearbox;
a generator shaft and gearbox output shaft coupled between the generator and the gearbox, each shaft extending along a common longitudinal axis;
a brake system comprising:
at least two brake disks comprising a first brake disk and a second brake disk, the first and second brake disks mounted concentric with the longitudinal axis; and,
a plurality of disk brake calipers comprising a first brake caliper and a second brake caliper, the first and second brake calipers mounted concentric with the longitudinal axis and configured to engage with the first and second brake disks, respectively.

2. The drivetrain system of claim 1, wherein the brake system further comprises at least one of a mechanical brake system, a hydraulic brake system, a pneumatic brake system, or an electromagnetic brake system, and combinations thereof.

3. The drivetrain system of claim 1, wherein the first and second brake calipers are removably coupled to the generator and the gearbox, respectively.

4. The drivetrain system of claim 1, wherein the brake system further comprises a brake system control circuit configured to apply an individually-variable brake torque to the first and second brake disks, respectively.

5. The drivetrain system of claim 4, wherein the individually-variable brake torque is based on at least one dynamic operating parameter.

6. The drivetrain system of claim 5, wherein the at least one dynamic operating parameter is measured by at least one sensor communicating with a turbine controller.

7. The drivetrain system of claim 6, wherein the at least one dynamic operating parameter comprises at least one of a generator shaft torque or a gearbox output shaft torque.

8. A method for braking a wind turbine, the method comprising:
mounting a first brake disk concentric with a generator shaft adjacent to a generator of the wind turbine;
mounting a second brake disk concentric with the gearbox output shaft adjacent to a gearbox of the wind turbine;
mounting a first and second brake calipers that are configured to engage the first and second brake disks, respectively;
measuring at least one dynamic operating parameter during operation of the wind turbine; and,
adjusting individual brake torques applied by the first and second brake disks based on the measured dynamic operating parameter so as to obtain an equivalent brake torque to the generator shaft and gearbox output shaft from the first and second brake disks.

9. The method of claim 8, further comprising removably coupling the first and second brake calipers to the generator and the gearbox, respectively.

10. The method of claim 8, further comprising applying individually-variable brake torque to the first and second brake disks via a brake system control circuit.

11. The method of claim 10, further comprising conditioning individual control signals to the first and second brake disks based on the measured dynamic operating parameter.

12. The method of claim 11, further comprising measuring the at least one dynamic operating parameter by at least one of a turbine controller or one or more sensors.

13. The method of claim 12, wherein the at least one dynamic operating parameter comprises at least one of a generator shaft torque or a gearbox output shaft torque.

14. A brake system for a wind turbine, the brake system comprising:
a first brake disk mounted concentric with a longitudinal axis of a generator shaft of a generator of the wind turbine;
a second brake disk mounted concentric with the longitudinal axis of the gearbox output shaft; and
a first brake caliper concentric with the generator shaft and engaged with the first brake disk; and,
a second brake caliper concentric with the gearbox output shaft and engaged with the second brake disk.

15. The brake system of claim 14, wherein the brake system comprises at least one of a mechanical brake system, a hydraulic brake system, a pneumatic brake system, or an electromagnetic brake system, and combinations thereof.

16. The brake system of claim 14, wherein the first and second brake calipers are removably coupled to the generator and the gearbox, respectively.

17. The brake system of claim 14, further comprising a brake system control circuit configured to apply an individually-variable brake torque to the first and second brake disks, respectively.

18. The brake system of claim 17, wherein the individually-variable brake torque is based on at least one dynamic operating parameter.

19. The brake system of claim 18, wherein the at least one dynamic operating parameter is measured by at least one sensor communicating with a turbine controller.

20. The brake system of claim 19, wherein the at least one dynamic operating parameter comprises at least one of a generator shaft torque or a gearbox output shaft torque.
